(19) United States
(12) Patent Application Publication
(10) Pub. No.: US 2007/0282791 A1
(43) Pub. Date: Dec. 6, 2007

(54) User group identification

(76) Inventors: Benny Amzalag, Givataim (IL); Rony Schechter, Nof-Yam (IL)

Correspondence Address: Martin D. Moynihan;PRTSI, Inc., P.O. Box 16446, Arlington, VA, 22215, US

(21) Appl. No.: 11/502,513

(22) Filed: Aug. 11, 2006

Related U.S. Application Data
(60) Provisional application No. 60/809,849, filed on Jun. 1, 2006.
(60) Provisional application No. 60/815,839, filed on Jun. 23, 2006.

(51) Int. Cl. G06F 17/30

(52) U.S. Cl. 707/2

(57) ABSTRACT

An apparatus for determining a relation between a user and a group of people, comprising: a) a group characteristic receiver, configured to receive at least one group of characteristics pertaining to a respective predefined group of people, b) a user data receiver, associated with the group characteristic receiver, and configured to receive data in respect of at least some of the characteristics from a user, and c) a group relation determiner, associated with the group characteristic receiver, and configured to automatically determine a relation between the user and the predefined group using at least some of the characteristics pertaining to the identified group of people and corresponding data received from the user.

### RELATED APPLICATIONS

The present application claims priority from U.S. Patent Application No. 60/809,849, filed on Jun. 1, 2006 and from U.S. Patent Application No. 60/815,839, filed on Jun. 23, 2006, the contents of which are incorporated herein by reference.

### FIELD AND BACKGROUND OF THE INVENTION

The present invention relates to user identification, and more particularly, but not exclusively to a system and method for determining user group relations in a communication network.

Over the past few years the use of the Internet as a means of communication has increased greatly and many Internet users via Internet implemented services such as chats, forums, blogs, instant messenger programs, etc.

However, a major problem with the Internet is the lack of reliable ways to identify Internet users, or to verify an Internet user's declared identification details. The problem results in a growing number of Cyber crimes. In many Cyber crimes, criminal users abuse services such as chats, forums, blogs, and instant messenger programs, for committing cyber crimes such as pedophile-type crimes against children, fraud, and identity theft.

Chats, blogs and forums serve as a meeting place, a way of sending a message or a place for conversation and discourse for many people including children and youth. Because of the lack of reliable ways to identify Internet users, there are many cases of fake identities and impersonation. Specifically, there are many cases of pedophile adults pretending to be children and taking advantage of the anonymity provided by the Internet to make contact with children.

The nature of Internet crime presents complex new challenges for law enforcement agencies and victim service providers with regard to investigating crimes, collecting evidence, identifying and apprehending offenders, and assisting victims and their families.

Very often, victims and perpetrators of Cybercrime are often separated geographically, which may hamper investigation efforts. Also, victims are often ashamed and reluctant to come forward, which makes identifying offenders difficult. These challenges are being addressed by federal and local law enforcement agencies, but there is still much to learn and do about preventing Cybercrime by more reliable identity verification methods,

Presently, there are several user authentication methods.

For example, a logon process is used by communication networks, using a password and a User ID provided to each user authorized to access the network, through a user account set for the user by an operator of the communication network.

Other logon process methods combine a password with a physical token such as a magnetic card. Such methods are known in the art as Two Factor Authentication Methods, combining a password known to the authorized user, and something possessed by the authorized user.

Three Factor Authentication Logon Process Methods are based on a password known to the authorized user, something possessed by the authorized user, and a biometric indicator such as a fingerprint, or a voice signature.

Logon processes are suited to services offered to users known in advance, such as bank clients, etc. In order for the user to be identified, the network administrator has to know each and every user and create for each individual user his own account prior to his entering the network.

However, logon processes are not suited for services offered to the general public, which may be used by any member of the general public. Usually, the member of the general public is not known in advance to the operator of the service. Consequently, the operator cannot set up an account for the user prior to his entering the network.

General User Identification methods are very common in the Internet environment—in as web forums, chats, blogs, etc.

A general user identification is also achieved by the logon process, but in this case there is no way of knowing the user's true identity, because the user himself sets up the account and not the system administrators and he himself provides his own personal information.

The information required for setting up a new user account usually includes the following details: User ID, Password, and e-mail address. The information may also include other details such as sex, date of birth, home address, occupation, and other details. However, the account is set up without any monitoring. Consequently, there is no way to verify the details provided by the user. The user may create one or more user accounts at the same web site, using a false identity including details such as age, sex, etc.

Many Internet applications do not use any registration, user ID, password, or other identification method at all.

One approach to the problem of identifying Internet users is to determine an affinity between users.

One way currently used for determining affinity between users is based on e-mail address similarity amongst users (For example, employees of the same company or student of the same university usually have the same e-mail address suffix). However relaying on similarity amongst email addresses is a very limited method, as many not having similarity between their e-mail addresses may still have a lot in common.

Another way for determining affinity between users is by allowing a user to define a group and let the user control the access of other users to the group. However, the user who defines the group may use rather arbitrary and subjective criteria for allowing users to join the group. Furthermore, the determination of the affinity is carried out non-automatically, and inefficiently.

US Patent Publication No. 20050076103, to Hilf et al, entitled “Real time web session affinity identification and user bonding”, filed on Sep. 22, 2003, describes a method, a system and a computer readable storage for creating user groups in a network environment.

The method introduced by Hilf includes monitoring a plurality of user sessions, each associated with a different user, and identifying at least one affinity among the user sessions. Responsive to the affinity identification, at least one action can be initiated, for example, presenting a user interface to at least one of the users or prompting users to engage in communication.

However, the Hilf method is limited to a real time and usually temporary affinity between users, which is very often limited by the length of the session where the users in the group interact with each other, say in a web chat. With Hilf, the group may be very heterogenic. For example, very different Internet users may surf on the same web site at a certain time.

There is thus a widely recognized need for, and it would be highly advantageous to have, a system devoid of the above limitations.

### SUMMARY OF THE INVENTION

According to one aspect of the present invention there is provided an apparatus for determining a relation between a user and a group of people, comprising: a) a group characteristic receiver, configured to receive at least one group of characteristics pertaining to a respective predefined group of people, b) a user data receiver, associated with the group characteristic receiver, and configured to receive data in respect of at least some of the characteristics from a user, and c) a group relation determiner, associated with the group characteristic receiver, and configured to automatically determine a relation between the user and the predefined group using at least some of the characteristics pertaining to the identified group of people and corresponding data received from the user.

According to a second aspect of the present invention there is provided a method for determining a relation between a user and a group of people, comprising: a) receiving at least one group of characteristics pertaining to a respective predefined group of people, b) receiving data relating to the characteristics from a user, and c) automatically determining a relation between the user and the identified group using at least one of the characteristics of the identified group of people.

According to a third aspect of the present invention there is provided an apparatus for determining a relation between a user and a group of people, comprising: a) a group characteristic receiver, configured to receive at least one group of characteristics pertaining to a respective predefined group of people, b) a user data receiver, associated with the group characteristic receiver, and configured to receive data in respect of at least some of the characteristics from a user, c) a group relation determiner, associated with the group characteristic receiver, and configured to automatically determine a relation between the user and the predefined group using at least some of the characteristics pertaining to the identified group of people, and d) an access controller, associated with the group relation determiner, and configured to control access to an application according to the determined relation

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a block diagram illustrating an apparatus for determining a relation between a user and a group of people, according to a preferred embodiment of the present invention.

FIG. 1B is a block diagram illustrating a second apparatus for determining a relation between a user and a group of people, according to a preferred embodiment of the present invention.

FIG. 2 is a flowchart illustrating a method for determining a relation between a user and a group of people, according to a preferred embodiment of the present invention.

FIG. 3 is a flowchart illustrating a second method for determining a relation between a user and a group of people, based on knowledge shared by members of the group, according to a preferred embodiment of the present invention.

FIG. 4 is a flowchart illustrating a third method for determining a relation between a user and a group of people in a communication network, based on knowledge shared by members of the group, according to a preferred embodiment of the present invention.

FIG. 5 is a block diagram illustrating exemplary knowledge collection, in accordance with a preferred embodiment of the present invention.

FIG. 6 is a flowchart illustrating an exemplary scenario for determining a relation between a user and a group, according to a preferred embodiment of the present invention.

### DESCRIPTION OF THE PREFERRED EMBODIMENTS

The present embodiments comprise an apparatus and method for determining a relation between a user and one or more groups of people. Through determining if and how a user relates to a certain group of people, there is achieved characterization of the user, verification of identifying data provided by the user, etc. The embodiments may be used by Internet providers who provide services to particular groups or communities to restrict access to an application, to restrict communication between members of Internet users, to channel targeted messages (say advertisement messages) to members of certain groups, or for other implementations, as described in further detail hereinbelow.

The relation is decided by the ability of a candidate member to answer a series of questions in a manner which statistically reflects the answers of the group as a whole.

The principles and operation of an apparatus according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Preferred embodiments of the present invention are based on the idea that people, who belong to a certain group, share common knowledge consisting of characteristics of the group. The commonly knowledge, though significantly shared by the member of the group, is not significantly known to the general public, and not easily obtainable by members of the general public.

For example, a group of students, who study in the same high school, share knowledge pertaining to the group: names of the most and least popular teachers, the name of the best player on the school's baseball team, name of the most popular student, etc.

Optionally, the determined relation is used as a basis for controlling user access to a web site, a data base, an application, etc.

The control of access is based on an examination of the knowledge a user has with respect to the common knowledge pertaining to the group. The knowledge is significantly shared by the members of the group, but not significantly known to the general public.

Optionally, using an apparatus according to a preferred embodiment of the present invention, an unwanted user is filtered out without having to find out details specific to the unwanted user.

The filtering is based on the idea that group members share common knowledge which pertains to the group and is not significantly known or not available to the general public. Preferably, the filtering is not based on personal information of the group members, but rather on what constitutes common knowledge (or opinions) specific to the group and/or to the group members.

For example, an Internet user, who enters a certain school's web site or a school specific application in a social web site, an Internet user who enters a teenager chat room in a certain web site, etc, may be asked relevant questions. The relevant questions may include, but are not limited to: who is the best player of the school's baseball team? What are the names of the most or least popular teachers? Who is the best swimmer in the school swimming team? Who is the prettiest girl in a certain grade of the school? Etc.

If the user provides answers which statistically reflect the answers of the group of the students of the school as a whole, there is determined that the user has a relation to the school. That is to say, the user is verified as a student of the school, and allowed access to the web site of the school. If the user fails to provide statistically reflecting answers, the user is denied access, as it is determined that the user has no relation to the school.

For example, there may be decided that if answers provide by the user are at least 60% correlated with the answers from the survey, there is determined that the user is a student of the school.

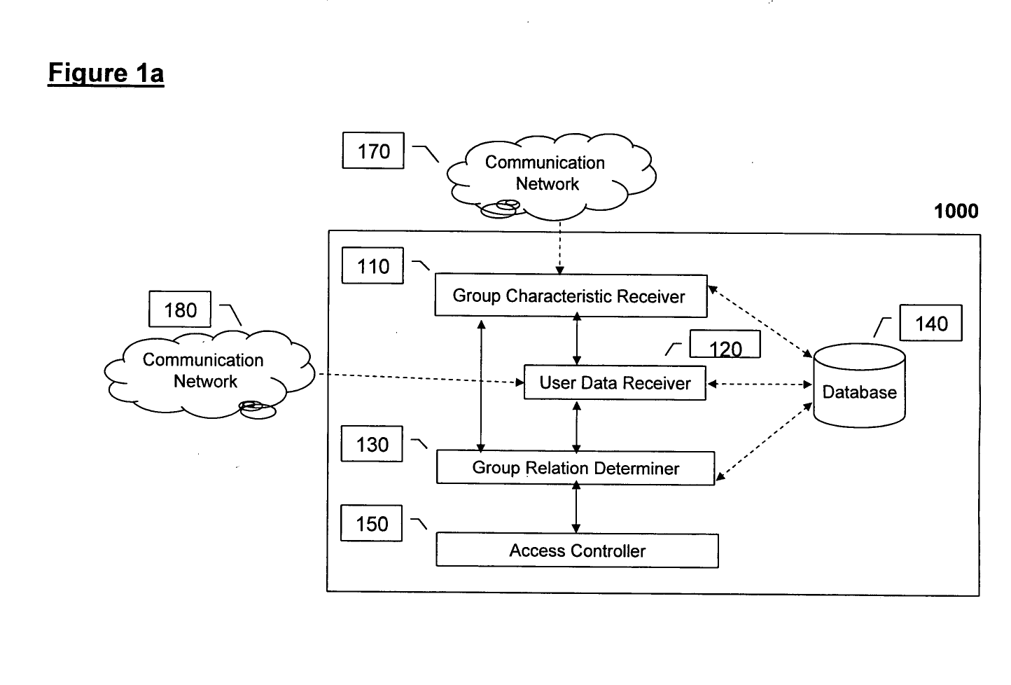

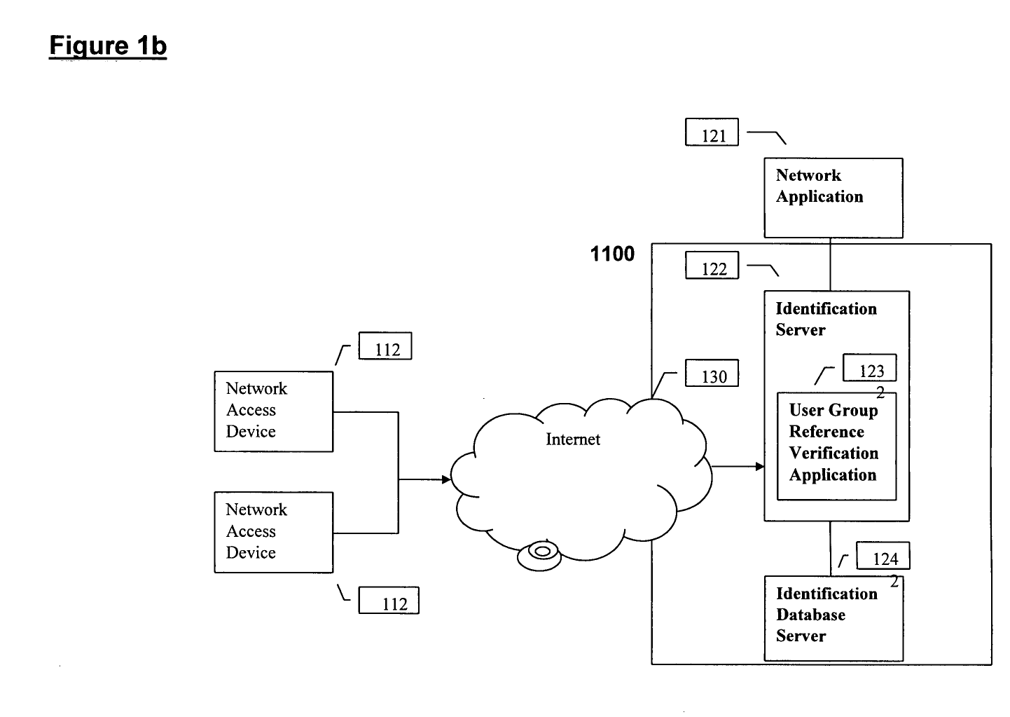

Reference is now made to FIG. 1a, which is a block diagram illustrating an apparatus for determining a relation between a user and a group of people, according to a preferred embodiment of the present invention.

Apparatus 1000 comprises a group characteristic receiver 110, for receiving one or more groups of characteristics pertaining to a predefined group of people. Preferably, the characteristics pertain to information which exists before the characteristics are received.

For example, for a group of students of a certain university department, there are found certain characteristics that are not significantly known to members of the general public. The characteristics may include the name of the most attractive student in the department, the name of the department secretary, the name of the student who works as an assistant to a certain lecturer, the name of the coach of the school's basketball team, etc.

Optionally, the characteristics may be collected through an on-line survey. For example, a survey about the certain group may be carried out using the group characteristic receiver 110, through a communication network 170 including but not limited to: the web (say when a user fills an on-line registration form), an organizational computer network, a cellular telephony network, etc.

Preferably, the characteristics are stored in a dedicated database.

Preferably, the characteristics are continuously updated, say when new users register to the web site. That is to say, as more users register to the web site, new characteristics may be added to the database and existing characteristics may be updated.

Optionally, the characteristics may be collected in a non-online survey, say using questionnaire forms given to the members of the groups to fill manually, or to a representative group chosen from amongst the members of the group. The characteristics pertaining to each group are then input to the group characteristic receiver 110.

Preferably, the group characteristic receiver 110 stores the characteristics in a dedicated database 140.

Optionally, the database 140 may be composed of the most frequent answers provided by members of each group.

Preferably, the characteristics stored in the database 140 are associated with an indication as to their frequency. Consequently, a statistical model pertaining to the group may be used for determining a user's relation to the group, as described in further detail herein below.

Optionally, the characteristics are fed to the group characteristic receiver 110 from an external database (say a database which holds information about students of a certain university, a database which holds information pertaining to top basketball players of the state, knowledge shared by basketball fans).

Preferably, the characteristics are retrieved from the external database using an interface such as a file formatted in accordance with an acceptable protocol, say using an EDI (Electronic Data Interchange) service, as know in the art.

Preferably, the group characteristic receiver 110 further includes a survey unit for collecting data in respect of the characteristics using an on line survey.

The apparatus 1000 also includes a user data receiver 120, connected to the group characteristic receiver, used for receiving data in respect of one or more of the characteristics from a user.

Optionally, the user provides the data using a communication network 180 such as the Internet, say when attempting to access a certain network application; the user may fill an on-line registration form.

For example, an Internet user attempts to access a certain Information System through a certain web site where certain Organizational Information Systems are accessible (say a portal, as known in the art).

Optionally, the data receiver 120 receives from the Internet user data which identifies one of the predefined groups of people (say, the university department of the user, the age group the user claims to belong to, etc). Consequently, the user's access to data stored in the Information System may be restricted in accordance with a determined relation between the user and a group. For example, if the user is determined to belong to a group of students—he is granted access only to his personal data, whereas if the user is a faculty member he may be granted access to all student data.

Optionally, the user may explicitly claim to have a relation to a predefined group—say, to be a student of a certain university. Preferably, the user implicitly provides data identifying a certain predefined group, such as his age (thus claiming to belong to a certain predefined age group).

Apparatus 1000 further comprises a group relation determiner 130, associated with the group characteristic receiver 110, which automatically determines a relation between the user and the identified group, say, if the user belongs to the identified group.

The group relation determiner 130 uses one or more of the characteristics pertaining to the identified group of people, for determining the relation between the user and the identified group of people.

For example, a use may input certain details when attempting to logon to certain web site, using the user data receiver 120. The details include his address, his age, and his workplace or the educational institution he attends, thus identifying a predefined group of people—say, students of a certain high school.

The group relation determiner 130 may then present the user with a series of questions, for testing his knowledge with respect to the characteristics pertaining to the group of people.

If the user seems to have the knowledge (i.e. provide the answers that are similar to answers provided by members of the group, say during a survey as described hereinabove), the group relation determiner 130 determines that the user has a relation to the group (say, that the user is a student of the certain high school).

If the user seems to lack the knowledge (i.e. fails to provide answers that are significantly similar to answers provided by members of the group), the group relation determiner 130 determines that the user has no relation to the group (say, to the certain high school). Optionally, the user (who may have criminal motivations) is denied access to the web site of the high school.

Preferably, the group relation determiner 130 uses a statistical model for determining if the user belongs to a certain group.

That is to say, members of a group generally share a certain body of knowledge and a series of questions can be constructed which can statistically separate between members of the group and outsiders.

Consequently, knowledge available only to members of the group may be obtained through a survey and the statistical model may be used for determining the relation of the user to the group, as described in further detail hereinabove.

For example, the knowledge of the group members who provide the characteristics pertaining to the group may be used to create a statistical model. The statistical model may be used to determine what percentage of the characteristics is known to an average team member.

Then, the group relation determiner 130 examines the level of knowledge the user has with respect to the characteristics, and compares the level of knowledge with the knowledge of the average group member.

Then, the group relation determiner 130 uses a predefined knowledge threshold for determining the relation of the user to the group, based on the statistical model.

In one example, a pedophilic user may contemplate entering a social web site, while presenting himself as a teenager (say using an on-line user registration form for the web site). The pedophilic user may further contemplate chatting with a teenager in the web site, and tempt the teenager to meet with him.

Using the user data receiver 120, the pedophilic user is asked relevant question for determining his relation to a predefined age group of teenagers. The group relation determiner 130 determines that the user is not related to the predefined group of teenagers. Consequently, the user may be blocked from communicating with the members of the group (i.e.—the pedophilic user is blocked from communicating with teenagers in the chat room and from sending messages to a teenager).

Similarly, the group relation determiner 130 determines for a certain user that the user has a relation to a specific group of teenagers; say that the user is a teenager studying in a certain grade of a specific high school.

Furthermore, two or more groups of high school students may be merged in a wider group say to a general age group consisting of members younger than seventeen. Consequently, a user determined to belong to one of two the high school student groups is automatically determined to belong to the general age group of members under seventeen.

In yet another example, the user simply tries to access a web site restricted to a certain group of people—say, to teenagers interested in Rap Music, thereby implicitly claiming to be a member of a predefined group (namely—Teenagers interested in Rap Music). The group relation determiner 130 determines the age group of the user. If the user is determined to be a member of an age group consisting of teenagers, the group relation determiner 130 determines if the user is also a member of a predefined group of Rap Music Fans.

Preferably, the group relation determiner 130 re-determines the relation between the user and one or more group(s) of people, when new information is provided by one or more member(s) of the group(s), the user, or both.

Preferably, apparatus 1000 further includes a group definer. The group definer may be used by an operator, a system administrator, or another user of the apparatus 1000, for defining groups of people such as students of a certain school grade, a certain age group, etc.

Optionally, the user/operator/administrator may use the group definer for deciding which attributes are to be sampled for each group of people, as described in further detail hereinbelow.

Preferably, the apparatus 1000 also includes a user characterizer. The user characterizer may be used for characterizing a user, based on a relation determined between the user and a group.

For example, if a user is determined to belong to a group of students of a certain university faculty, the user characterizer may characterize the user as: a university student, studying in the specific university, having the tastes and preferences as evident from the characteristics established for the students of the university, etc.

Consequently, the characterization of the user may be useful for a variety of marketing procedures.

For example, a user found to belong to a high school in a certain town may be targeted in a marketing campaign based on characteristics found for the group. For example, the user may be offered merchandise by a local shop which specializes in products relevant for high school students.

Optionally, the apparatus 1000 also includes an access controller 150, for controlling access to a certain web site, an information system, a certain facility, for controlling communications among users, etc.

For example, the access controller may be used to block communications between a user and a member of a group of teenagers if the user is not determined to belong to the group, as described in greater detail hereinabove.

Preferably, the apparatus 1000 also includes an alert unit.

The alert unit may trigger an alert, predefined by an operator or a system administrator.

For example, the operator may configure the alert unit to trigger a pedophile alert when a user who presents himself as a teenager (say by providing a false date of birth when registering to a web site for teenagers) is found not to belong to a predefined age group of teenagers.

Preferably, the apparatus 1000 also includes a user marker.

The user marker may be configured to mark a user based on the relation determined between the user and a group of people.

For example, the user marker may mark a user in a chat room using a specific symbol attached to the user's name in a list of chatting users displayed in the chat room, as known in the art.

Reference is now made to FIG. 1b, which is a block diagram illustrating a second apparatus for determining a relation between a user and a group of people, according to a preferred embodiment of the present invention.

A user may communicate with an application such as Chat forum implemented in a web site. The user may use a network access device 112, for communicating an application through a communication network, say the Internet 130. The network access device 112 may be a terminal, a desktop computer, a mobile computer, a cellular telephone, etc.

The communication network may have any topology, including but not limited to: Star, Bus, Token Ring, and a Mesh Topology, as known in the art. The network may include local area networks (LANs), wide area networks (WANs) and metropolitan area networks (MANs) and may be a public or a private network.

The communication network may be established on any type of physical links. For example, optical fiber, Unshielded/shielded Twisted Pair and coaxial cable. The communication network may use any known telecommunications type. For example, line base communications, wireless communications. The communication network may be based on any type of network methodology, for example—packet-switched communication methodology.

Apparatus 1100 includes an identification server 122, interacting with the user for verifying his identity, that is to say, for verifying the relation between the user and a group of people, say for deciding if the user is granted access the application.

The identification server 122 includes a user group reference verification application 123 implementing apparatus 1000, for determining the relation between the user and a predefined group, say between a user and a group of students of a certain grade in a certain town, as described in further detail hereinabove.

Preferably, the identification server 122 utilizes a dedicated identification database server 124, for storing the information shared by members of the groups of people. That is to say, the database server 124 stores the characteristics pertaining to each predefined group of people, as described in further detail hereinabove.

The identification server 122 controls the access of users to a network application 121.

The network application 121 may include: chats, forums, blogs, instant messaging applications, etc.

The network application 121 may be a local application that is installed on a user's local computer or a remote application that is installed on a remote server. The network application 121 may be firmware, executable software, or any currently known application type. The network application 121 may be a hardware device, or a software system, or software and hardware combination.

The identification server 122 may be implemented on any kind of hardware or software platform, or on any hardware and software combination platform.

The identification server 122 may implement any type of application, such as the user group verification application 123, in order to provide services to the same computer or to other computer programs and their users, on the same or other computers.

The identification server 122 may be communicated with any kind of a network access device 112 which provides a gateway to the network.

Optionally, the identification server 122 interfaces with the user reference verification application 123, the dedicated database server 124, and the network application 121, or any other server or application for performing various tasks.

Optionally, the user group reference verification application 123 is used to verify or determine the relation of the user to a group, for deciding whether to grant the user general access to the network application 121.

Optionally, the user group reference verification application 123 is used to verify or determine the relation of the user to a group, for deciding whether to grant the user access to an application which facilitates a communication channel between users. The application may include, but is not limited to: a chat room, a messenger, etc.

Preferably, the user reference verification application 123 is installed on the identification server 122. Optionally, the user reference verification application 123 is installed on another server and communicated by the identification server 122, for deciding whether to grant the user access to the network application 121.

The identification application 123 may be installed on a central computer or on several computers that are spread out on different location. The identification application 123 may communicate with a single user or a number of users at the same time.

The dedicated database identification server 124 is implemented on a storage device which stores a collection of information such as user information. The database server 124 may be a server implemented on a single computer, or a distributed database server implemented on a group of computers.

The database server 124 may be based on a relational database or any other kind of a database. The database server 124 may be installed on various devices, such a physical device including but not limited to a magnetic or an optical device.

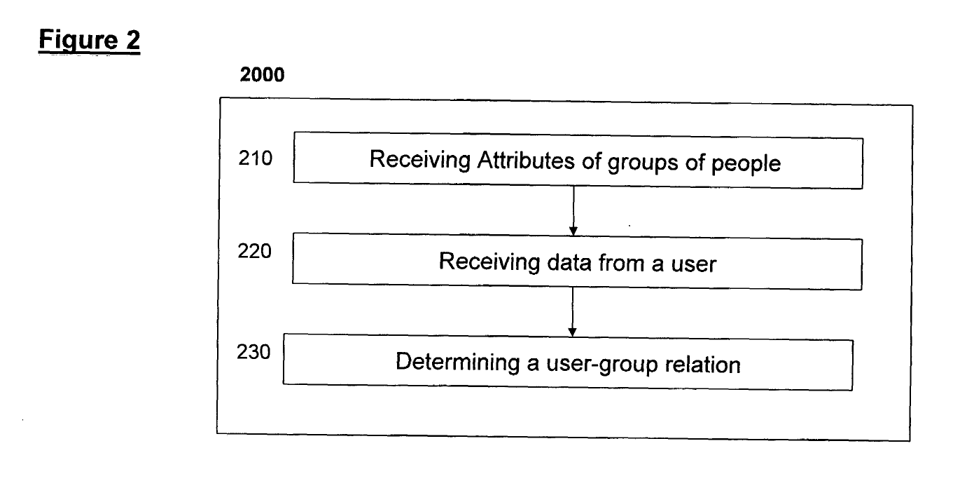

Reference is now made to FIG. 2, which is flowchart illustrating a method for determining a relation between a user and a group of people, according to a preferred embodiment of the present invention.

According to method 2000 for determining a relation between a user and a group of people, one or more groups of characteristics pertaining to a predefined group of people is received 210, say by a group characteristic receiver 110, as described in further detail hereinabove.

Optionally, the characteristics may be collected through an on-line survey. For example, a survey about the certain group may be carried out using the group characteristic receiver 110 through the web, or through any other communication network used by the members of the group, say a university computer network.

Optionally, the characteristics are collected in a non-online survey, say using questionnaire forms given to the members of the groups to fill manually, or to a representative group chosen from amongst the members of the group. The representative group may be chosen randomly, or through any other method, as known in the art.

The characteristics pertaining to each group may then be input to the group characteristic receiver 110, as described hereinabove.

Next, there may be received 220 data identifying one of the predefined groups of people from a user, say using a user data receiver 120, as described hereinabove.

For example, a user may be requested to input his birth date, thus implicitly claiming to have a relation with a predefined group of people in a certain age group.

In other example, the user may present himself as a student of a certain university; the user may request access to a web site of a certain school, etc.

Finally, there is automatically determined 230 a relation between the user and the identified group, using one or more of the characteristics of the group of people identified by the user.

Optionally, the group relation determiner 130, described hereinabove, uses one or more of the characteristics pertaining to the identified group of people, for determining the relation between the user and the identified group of people.

For example, the user may be presented with a series of questions, for testing his knowledge with respect to characteristics pertaining to the group of people. The questions are based on the same questions used for receiving the characteristics, say by the group characteristic receiver 110 described hereinabove.

If the user seems to have the knowledge, there is determined that the user has a relation to the group (say, that the user is a student of the certain high school).

If the user seems to lack the knowledge (i.e. fails to provide answers which bear significant correlation to answers provided by the members of the group in the survey), there is determined that the user has no relation to the group (say, to the certain high school), as described in further detail hereinabove.

Preferably, the determination of the relation is based on a statistical model. Using the statistical model, the knowledge the user seems to have may be compared with the knowledge that the people of the group have. Then, a statistical comparison may be made between the knowledge possessed by the user and the knowledge the people of the group have. Based on the comparison, there is determined the relation between the user and the group, as described in further detail hereinabove.

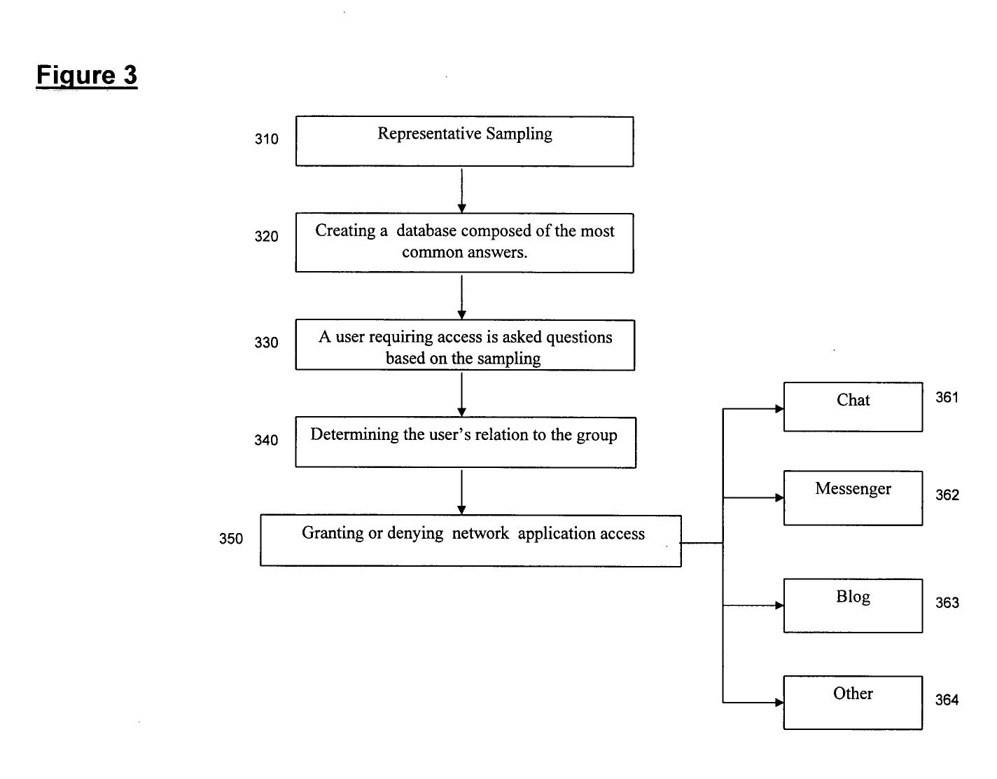

Reference is now made to FIG. 3, which is a flowchart illustrating a second method for determining a relation between a user and a group of people, based on knowledge shared by members of the group, according to a preferred embodiment of the present invention.

First, knowledge shared by members of a group, as defined by an operator of an apparatus 1000 is collected by sampling 310 the group members.

Optionally, the knowledge includes characteristics collected through a survey carried out on-line through a communication network (the Internet, an organizational computer network, etc.).

Preferably, the characteristics are collected using questionnaire forms, filled manually by representative members of the group. In one example, there is defined a group of people who are students of a certain University Faculty. A survey is carried out using questionnaire forms given to students present in the building of the faculty.

After the forms are filled by the students, the information in the filled forms may be input, say using the group characteristic receiver 110, as described hereinabove. Optionally, the characteristics are input to the group characteristic receiver 110 manually. Preferably, the characteristics are input to the group characteristic receiver 110 through an automatic process, as known in the art.

Preferably, the characteristics received for each group of people are stored 320 in a database 140, composed of the most common answers.

For example, a group of students of a certain school may be asked questions which relate to the school or a specific grade of the school, such as: who is the most attractive student, who is the best player in the school baseball team, etc. The most common answers may be stored in the database 140, as described in further detail hereinabove.

Optionally, when a user requests access to a system implementing an apparatus 1000, there is carried out a process for verifying the relation of the user to a group of people allowed access to the system (say, the relation of the user to the group of students of a certain university faculty).

The user is asked 330 questions based on the characteristics sampled for the group of people, as described above. Then, a determination 340 is made with respect to a relation of the user to the group of people (say, that the user is a student of the certain university faculty). For example, the user may be asked questions, for examining his knowledge with respect to the characteristics sampled as described above.

Next, a determination 340 is made as to whether the user relates to a predefined group of people. The determination is based on the level of knowledge the user demonstrates with respect to the characteristics sampled for the group, as described in further detail hereinabove.

That is to say, the answers provided by the user are compared with the characteristics as sampled from the members of the group. If the answers provided by the user are statistically similar (or most of the answers are similar, as defined by an operator of the apparatus 1000) to the characteristics sampled for the group, it is determined that the user belongs to the group.

Based on the determined relation between the user and the group, the user may be granted 350 an account for the network application (a Chat, an Internet messenger, a Blog, or any other application 361-4).

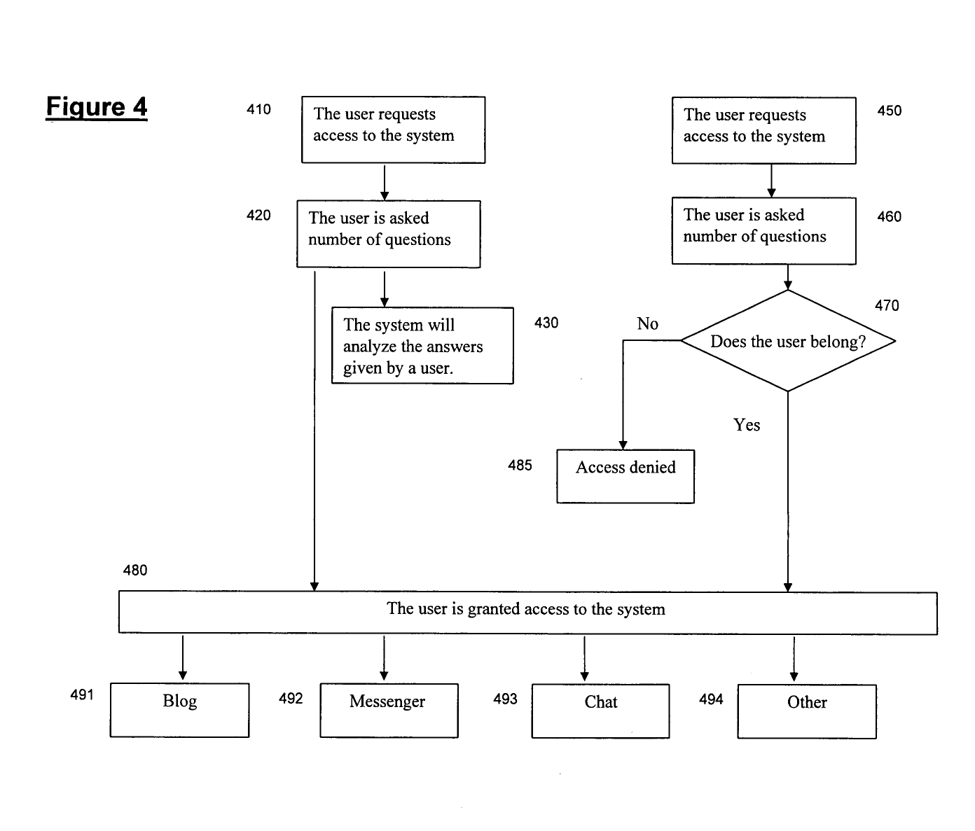

Reference is now made to FIG. 4, which is a flowchart illustrating a third method for determining a relation between a user and a group of people in a communication network, based on knowledge shared by members of the group, according to a preferred embodiment of the present invention.

A database 140 of attributes, where each group of characteristics pertains to a predefined group of people (students of the same grade, football fans of a certain group, people having the same hobby, etc) may be used in a two stage process.

In the first stage, each user who requests access 410 to a certain application on a certain communication network (say a certain web site) is asked 420 a number of questions, before allowing the user to access the application 480.

In the first stage, there is not enough data for building the database 140. That is to say, the characteristics pertaining to the group of people that are allowed access to the application are not significantly established yet.

The answers provided by the users are analyzed 430, and the most popular answers are recorded in the database 140 as characteristics pertaining to the group of people allowed access to specific application. The more answers are provided and the more users provide the answers, the more established the characteristics in the database 140 become.

The second stage starts when there is decided, say by an operator or a system administrator of the apparatus 1000, that the characteristics are well established.

In the second stage, when a user requests 450 an access to the application, the user is asked 460 one or more questions.

The questions are based on the questions of the first stage. However, the answers provided by the user are compared with the characteristics established in the first stage.

Through comparing the answers provided by the user and the characteristics, a decision is made 470 with respect to a relation between the user and the group.

Optionally, the comparison is based on a deterministic model.

For example, a first operator of an apparatus 1000 may decide that only if the user answers fully match answers provided by members of the group, is the user allowed access to the application. A second operator of the apparatus 1000 may decide that at least half of the user answers have to match answers provided by members of the group, in order to be granted access to the application, etc.

Preferably, the comparison is based on a statistical model.

Using the statistical model, the knowledge demonstrated by the user with respect to the characteristics of the group is statistically compared with the knowledge demonstrated by the users in the first stage. The statistical significance of correct answers provided by the user serves to determine the relation between the user and the group.

For example, a statistical model may be based on a finding that 90% of the group members know 70% or more of the characteristics of the group, whereas only 1% of the general population knows 70% or more of the characteristics of the group. Consequently, there may be decided that a user who knows at least 70% of the characteristics is determined to belong to the group.

If it is decided that the user belongs to a group allowed access to the application, the user may be granted a password 480 to the application (a Chat, an Internet messenger, a Blog, or any other application 491-4). Otherwise, the user's request to access the application is refused 485.

A preferred embodiment of the present invention may implement one or more of current methods for improving the quality of the sampled data, prevent data redundancy, eliminate biased data, etc. For example, when carrying out an on-line survey for a certain group of people, it may be required to prevent multiple participation of the same user in the on-line survey.

Other examples include, but are not limited to: carrying out a partial non on-line survey to verify the answers provided on-line, comparing the results of the survey with results of surveys carried out for the group or for a related group. For example, members of several grades in a certain high school may be asked questions which pertain to a specific one of the grades.

Optionally, there may be used one of several currently known methods for preventing multiple participation of a user in the survey. The prevention may be based on comparing IP addresses of computers used for participation in the survey, on comparing e-mail addresses, on a unique key provided to each specific user who participates in the on-line survey, etc.

Preferably, there may be implemented, say using the group characteristic receiver 110, rules defined by a system administrator, for removing suspiciously biased answers provided by users through an on-line survey.

Examples may include, but are not limited to: ignoring answers provided by users who remain inactive after their participation in an on-line survey, eliminating answers provided by users who seem to provide answers statistically deviant from answers provided by the majority of other users, etc.

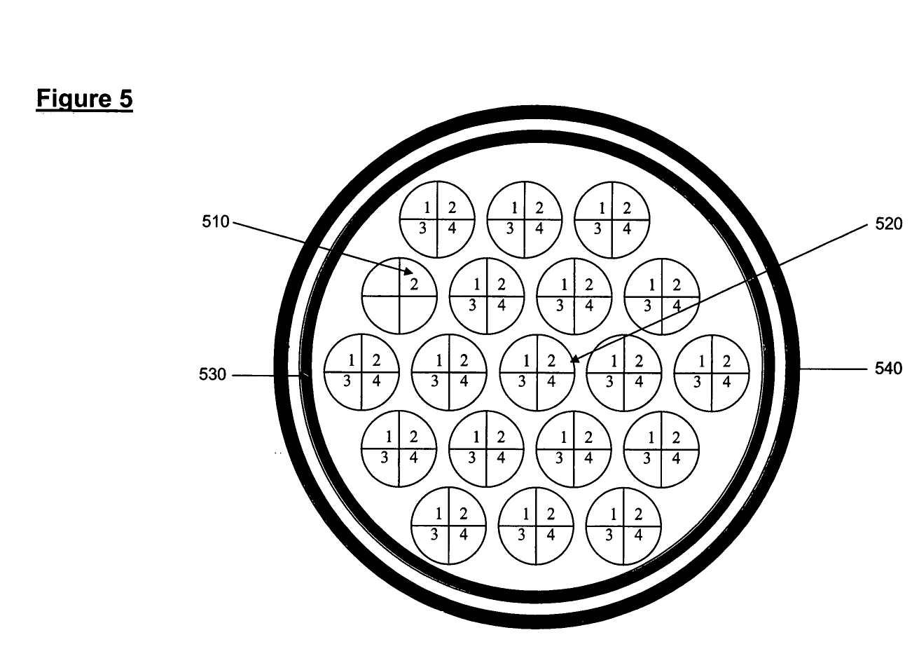

Reference is now made to FIG. 5, which a block diagram illustrating exemplary knowledge collection, in accordance with a preferred embodiment of the present invention.

According to a preferred embodiment, in the long run, the more groups are sampled, the wider the knowledge collected becomes.

As more knowledge is gathered, say using the group characteristic receiver 110, the knowledge gathered may support the definition of higher groups. A higher group is a group comprising previously defined smaller groups, and having a knowledge base. The knowledge base consists of the characteristics sampled for each of the previously defined and sampled groups.

For example, the knowledge gathered by an apparatus 1000 may evolve from knowledge pertaining to a specific grade of a specific school 510 into knowledge pertaining to the whole school 520. Next, the knowledge evolves into knowledge pertaining to all schools in a certain region of a state 530, and then into knowledge spanning all schools in the state 540.

As a result, groups pertaining to specific school grades may be merged to form school groups, the school groups may be merged to form regional youth groups, and the regional youth schools may be merged to form a group generally representing the youth of the state.

Consequently, the group generally representing the youth of the state may be used to determine a relation between a user and the youth of the state, say for detecting an adult trying to communicate with a teenager, as described above.

Preferably, the group definer may be used by a user of the apparatus 1000 for defining a higher group from lower groups, as described in further detail hereinabove.

The process of Choosing the Right Questions

Choosing questions that are known only to the group members, or may easily be obtained by them, and that are known to the system administrator but are not known to the public, is not an easy task, because some of the data may be public data.

For instance, if the system asks the name of the grade's coordinator, this question may be problematic, because the data may be accessible in the school website, and may be inefficient for identifying the real members of the group.

An exemplary solution is to ask qualitative questions about life within the group, for example about dominant students in the user's grade, say the prettiest girl and the coolest guy in the grade. Apparently, the answers for such questions show significant similarity between students of the same members of the same group. Preferably, the similar answers comprise the shared knowledge of the group. The knowledge is significantly shared among members of the group, and not significantly known to the general public.

Another exemplary solution is to choose a very specific group, say a specific class of the specific grade of a certain school and to ask students of the grade questions pertaining to a specific class. By using questions pertaining to the specific class there are achieved more focused answers.

Another example is to ask a question like—What is the school timetable for a specific class on your grade on Monday”. However, the answer may be unavailable to many students of the grade.

Another exemplary question is the names of students in a specific class in specific grade.

Determining the Knowledge Shared by Group Members

Optionally, the shared knowledge is determined by a representative sample. After a representative sample is carried out among members of the group, the most common answers, given by the members of the closed group, constitute the characteristics of the group. Optionally, only a user who knows these answers may be allowed access to the website, and a user who doesn't know these answers is denied access.

Optionally, the shared knowledge is determined by presenting to each user, upon his entrance to the system or during his registration process, a series of questions which are used to collect the characteristics pertaining to a group of people, as described in further detail hereinabove.

Preferably, an operator of the apparatus 1000, decides when the data gathered by the questions described hereinabove is sufficient for establishing characteristic of predefined groups of people.

Another example: the system administrator wishes to conduct a chat, forum, blog or Internet game for the members of a specific group, such as soccer players and fans. The system administrator may prepare a list of questions that any soccer fan is able to answer for the most part, but someone who does not like soccer would only know a small portion of the answers.

Preferably, there are used statistical and probability tools in order to lower the chances of someone who is not a member of the group being allowed access, and maximize the chances of someone who is a member of the group being allowed access.

In order to calculate the various probabilities, the system administrator may conduct a statistical analysis of answers provided for the questions, in order to associate each answer with a statistical significance indication.

Preferably, a statistical model based on the answers provided by the members of the group may be used for determining the relation of a user to the group.

For example, there may be decided that only an attribute known to over 80% of the group members is usable for determining if a user is a member of the group.

For example, an administrator conducts statistical research. The results of this research show to a significance level of 0.01 that a soccer fan answers correctly at least 60% of the questions presented by the administrator. Thus the chance that a soccer fan is not allowed to access the site is 1%.

The administrator also conducts statistical research, the result of which is for example that there is a significance level of 0.04 that someone who does not like soccer is unable to answer 60% or more of the questions given. Consequently, a non-soccer fan has a 4% chance of being granted access to the site.

In accordance with the above example, if a user answers correctly over 60% of the questions—the user is allowed access to the site. However, a user who answers correctly less than 60% of the questions is denied access to the web site.

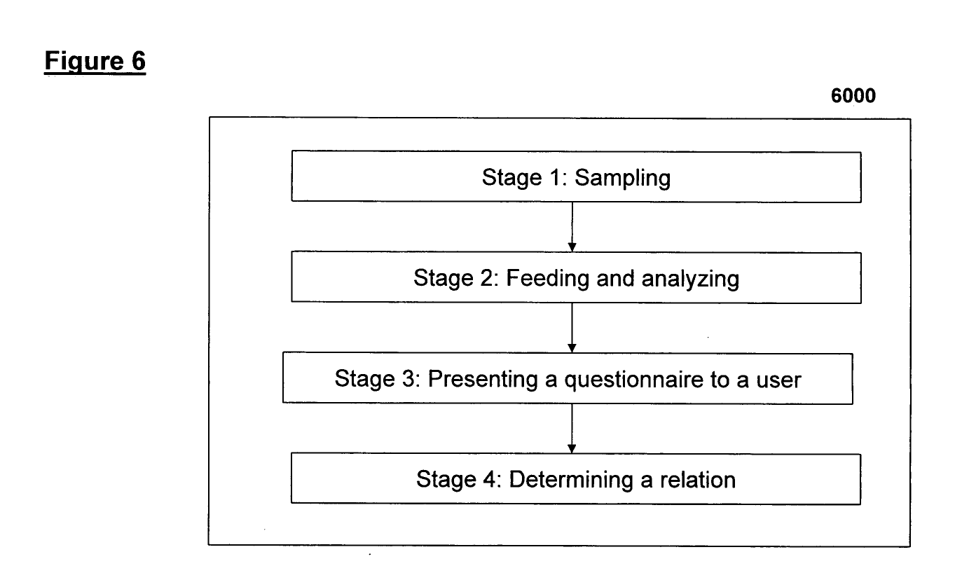

Reference is now made to FIG. 6 which is a flowchart illustrating an exemplary scenario for determining a relation between a user and a group, according to a preferred embodiment of the present invention.

In an Exemplary Scenario:

Stage 1—Performing the Representative Sample

A system administrator performs a physical or other representative sample, using manual questionnaire forms, for establishing knowledge shared by members of the particular group.

For example, a system administrator may conduct a survey among teenagers in the age 14-18 in a certain town. The answers to questions presented in the survey are used for establishing the characteristics pertaining to the age group. Finally, the characteristics are used for examining the knowledge a user attempting to access the town's web youth chat room has with regards to the characteristics. Based on the examination, there is determined the relation of the user to the group. If the user appears to have the relation to the group, the user is granted access to the town's web youth chat room.

Identifying the shared knowledge of the students according to the example above is performed on this way: First, a representative sample is performed. The students are asked one question or more about their grade. The questions may include questions that are based on individual taste like beauteousness, wisdom, athlete etc. or personal characteristics such as height.

For example: boys are asked about the most beautiful girls in their grade, and the girls are asked about the most handsome boys in their grade. As the answers to such non-deterministic questions may vary from one student to the other, they are used to form a statistical model of the knowledge shared by the members of the group.

Consequently, a user who requires access to the web site chat forum is not required to demonstrate absolute knowledge of the group. The user only has to know a portion of the answers which seems to fall in a certain acceptable range, based on the statistical model.

In other examples, the questions may deterministic. That is to say, the questions may pertain to facts rather than opinions: the name of the school manager, the name of the coach of the school baseball team, etc.

Typically, a member of the group knows these facts better than members of the general public. That is to say, one user may know the name of the coach, another user may know the name of the school manager, and another user may know the name of the grade coordinator. But members of the group (say, students of the specific class) are much more likely to know the three facts together.

Stage 2—Feeding and Analyzing the Answers

All the answers that are received in the representative sample are fed into the system.

The most popular answers, according to a criteria decided by the system administrator, are chosen as the characteristics pertaining to the group.

In order to improve the credibility of the comparison between the answers given, the system may use a search engine that is defined in a manner that slight insignificant variations between the answers, are removed (say, different spelling of the same family name).

Stage 3—Identifying Questionnaire

For example, a user attempting to access the web site is asked questions which are identical to the questions asked at the representative sample.

Stage 4—Determining a Relation Between the User and the Group

A user is asked questions for examining his knowledge with respect to the characteristics found for the group. Based on the knowledge demonstrated by the user, there is decided if the user relates to the group and how (say student of the class, a teacher of the class, etc).

Optionally, once the user-group relation is established, it is decided if the user is allowed to access the web site, as described in further detail hereinabove.

In another example, the sampling of the knowledge possessed by a member of the group is carried out on-line, over the Internet, rather than using manual forms in a physical survey.

It is expected that during the life of this patent many relevant devices and systems will be developed and the scope of the terms herein, particularly of the terms “Communication network”, “Internet”, “database”, and “Network application”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for determining a relation between a user and a group of people, comprising:
a) a group characteristic receiver, configured to receive at least one group of characteristics pertaining to a respective predefined group of people;
b) a user data receiver, associated with said group characteristic receiver, and configured to receive data in respect of at least some of said characteristics from a user; and
c) a group relation determiner, associated with said group characteristic receiver, and configured to automatically determine a relation between said user and said predefined group using at least some of said characteristics pertaining to said identified group of people and corresponding data received from said user.

2. The apparatus of claim 1, wherein said group characteristic receiver comprises a survey unit to collect data in respect of said characteristics using an on line survey.

3. The apparatus of claim 1, wherein said user data receiver is further configured to receive said data using an on-line questionnaire.

4. The apparatus of claim 1, wherein said characteristics pertain to knowledge existing prior to said receiving of said characteristics.

5. The apparatus of claim 1, wherein said group characteristic receiver, is further configured to receive a plurality of groups of characteristics, each group pertaining to a respective predefined group of people.

6. The apparatus of claim 1, further comprising a group definer, operable to define said group of people.

7. The apparatus of claim 6, wherein said group definer is further configured to define a higher group comprised of a plurality of said groups of people.

8. The apparatus of claim 1, wherein said group characteristic receiver is further configured to build a group knowledge statistical model based on said received groups of characteristics.

9. The apparatus of claim 1, wherein said group relation determiner is further configured to use a statistical model for said determining.

10. The apparatus of claim 1, wherein said a group characteristic receiver is further configured to use an interface to an external database for receiving said group of characteristics pertaining to a respective predefined group of people from said database.

11. The apparatus of claim 1, further comprising a user characterizer, configured to characterize said user, based on said determined relation.

12. The apparatus of claim 1, further comprising an alerter, configured to trigger a predefined alert based on said determining.

13. The apparatus of claim 1, further comprising an alerter, configured to trigger a predefined pedophile alert based on said determining.

14. The apparatus of claim 1, wherein said user data receiver is implemented in a communication network.

15. The apparatus of claim 1, wherein said user data receiver is implemented in the Internet.

16. The apparatus of claim 1, further comprising an access controller, configured to control access to an application according to said determined relation.

17. The apparatus of claim 1, further comprising a user marker, configured to mark a user according said determined relation.

18. Method for determining a relation between a user and a group of people, comprising:
a) receiving at least one group of characteristics pertaining to a respective predefined group of people;
b) receiving data relating to said characteristics from a user; and
c) automatically determining a relation between said user and said identified group using at least one of said characteristics of said identified group of people.

19. The method of claim 18, wherein said receiving comprises collecting said characteristics using an on line survey.

20. The method of claim 18, further comprising receiving said data relating to said characteristics from said user, using an on-line questionnaire.

21. The method of claim 18, wherein said receiving comprises collecting said characteristics using a non-on line survey.

22. The method of claim 18, wherein said characteristics pertain to knowledge existing prior to said receiving of said characteristics.

23. The method of claim 18, further comprising receiving a plurality of groups of characteristics, each group pertaining to a respective predefined group of people.

24. The method of claim 18, further comprising a preliminary step of defining said groups of people.

25. The method of claim 18, further comprising building a group knowledge statistical model based on said received groups of characteristics.

26. The method of claim 18, wherein said determining is based on a statistical model.

27. The method of claim 18, further comprising using an interface to an external database for receiving said group of characteristics pertaining to a respective predefined group of people from said database.

28. The method of claim 18, further comprising characterizing said user, based on said determined relation.

29. The method of claim 18, further comprising triggering a predefined alert based on said determining.

30. The method of claim 18, further comprising triggering a predefined pedophile alert based on said determining.

31. The method of claim 18, wherein said receiving data identifying one of said predefined groups from said user is carried out using a communication network.

32. The method of claim 18, wherein said receiving data identifying one of said predefined groups from said user is carried out using the Internet.

33. System for determining a relation between a user and a group of people, comprising:
a) a group characteristic receiver, configured to receive at least one group of characteristics pertaining to a respective predefined group of people;
b) a user data receiver, associated with said group characteristic receiver, and configured to receive data in respect of at least some of said characteristics from a user;
c) a group relation determiner, associated with said group characteristic receiver, and configured to automatically determine a relation between said user and said predefined group using at least some of said characteristics pertaining to said identified group of people; and
d) an access controller, associated with said group relation determiner, and configured to control access to an application according to said determined relation.
